(19) United States
(12) Patent Application Publication
(10) Pub. No.: US 2021/0382206 A1
(43) Pub. Date: Dec. 9, 2021

(54) FLEXIBLE WINDOW LAMINATE AND IMAGE DISPLAY DEVICE INCLUDING THE SAME

(71) Applicant: DONGWOO FINE-CHEM CO., LTD., Jeollabuk-do (KR)

(72) Inventors: Duck Kyeom KIM, Seoul (KR); Jeong Min CHOI, Gyeonggi-do (KR); Jin Ho BAE, Gyeonggi-do (KR)

(21) Appl. No.: 17/405,530

(22) Filed: Aug. 18, 2021

Related U.S. Application Data
(63) Continuation of application No. PCT/KR2020/001462, filed on Jan. 31, 2020.

(30) Foreign Application Priority Data
Feb. 19, 2019 (KR) 10-2019-0019359

(51) Int. Cl. G02B 1/14; G02B 1/04; G02B 5/30; G06F 3/041; G09F 9/30

(52) U.S. Cl. CPC G02B 1/14; G02B 1/04; G06F 2203/04102; G06F 3/0412; G09F 9/301; G02B 5/3033

(57) ABSTRACT

A flexible window laminate according to an embodiment of the present invention includes a window film, a urethane-based elastic film disposed on a bottom surface of the window film, and at least one of a polarizing layer and a touch sensor layer formed on a bottom surface of the urethane-based elastic film. Durability and impact resistance can be improved by including the urethane-based elastic film.

### CROSS REFERENCE TO RELATED APPLICATIONS AND CLAIM OF PRIORITY

The present application is a continuation application to International Application No. PCT/KR2020/001462 with an International Filing Date of Jan. 31, 2020, which claims the benefit of Korean Patent Application No. 10-2019-0019359 filed on Feb. 19, 2019 at the Korean Intellectual Property Office, the disclosures of which are incorporated by reference herein in their entirety.

### BACKGROUND

### 1. Field

The present invention relates to a flexible window laminate and an image display device including the same.

### 2. Description of the Related Art

Recently, a display device capable of displaying information including an image are being actively developed. The display device may include a flat panel display device such as a liquid crystal display (LCD) device, an organic light emitting display (OLED) device, a plasma display panel (PDP) device, a field emission display (FED) device, etc.

In the display device, for example, a window substrate for protecting a display panel such as an LCD panel and an OLED panel from an external environment may be disposed on an upper portion of the display panel. The window substrate may be formed of a glass. As a flexible display has been recently developed, a transparent plastic material has been used as the window substrate.

Additional members of the display device such as a polarizing plate, a touch screen panel, etc., may be disposed between the window substrate and the display panel. For example, an external light reflected from electrode patterns of the display panel may be blocked by the polarizing plate. A user's instruction may be input through a screen by the touch screen panel.

However, as a plurality of layers or structures such as the polarizing plate, the touch screen panel and the window substrate are stacked on the display panel, requirements of recent display devices such as improving flexible properties and reducing thickness, etc., may not be easily realized. Further, as the plurality of layers or structures are stacked, sufficient flexibility cannot be easily obtained while maintaining mechanical strength and stability.

For example, Korean Published Patent Application No. 2012-0076026 discloses a transparent substrate including a touch screen panel including a polarizing plate.

### SUMMARY

According to an aspect of the present invention, there is provided a flexible window laminate having improved mechanical reliability and flexible property.

According to an aspect of the present invention, there is provided an image display device including a flexible window laminate with improved mechanical reliability and flexible property.

The above aspects of the present invention will be achieved by the following features or constructions:

(1) A flexible window laminate, including: a window film; a urethane-based elastic film disposed on a bottom surface of the window film; and at least one of a polarizing layer and a touch sensor layer disposed on a bottom surface of the urethane-based elastic film.

(2) The flexible window laminate according to the above (1), wherein the urethane-based elastic film includes transparent polyurethane.

(3) The flexible window laminate according to the above (1), wherein a thickness of the urethane-based elastic film is from 20 to 250 μm.

(4) The flexible window laminate according to the above (1), wherein an elastic modulus of the urethane-based elastic film is from 5 to 15 MPa.

(5) The flexible window laminate according to the above (1), wherein the urethane-based elastic film has a JIS A hardness of 88 to 98.

(6) The flexible window laminate according to the above (1), wherein the urethane-based elastic film has a density of 1 to 1.5 g/cm³.

(7) The flexible window laminate according to the above (1), wherein the polarizing layer and the touch sensor layer are sequentially stacked from the bottom surface of the urethane-based elastic film.

(8) The flexible window laminate according to the above (7), further including a first adhesive layer disposed between the window film and the urethane-based elastic film layer, and a second adhesive layer disposed between the urethane-based elastic film and the polarizing layer.

(9) An image display device including the flexible window laminate according to embodiments as described above.

(10) The image display device according to the above (9), wherein the image display device is a flexible display device.

A flexible window laminate according to embodiments of the present invention may include a urethane-based elastic film and may be applied to an image display device. Accordingly, an external shock generated in an upper portion of a flexible display may be absorbed and buffered, thereby preventing damages to a touch sensor and the display device due to the external shock.

Further, the flexible window laminate may include the urethane-based elastic film to have improved folding properties while preventing damages due to the external shock.

### BRIEF DESCRIPTION OF THE DRAWINGS

FIGS. 1 and 2 are schematic cross-sectional views illustrating a flexible window laminate in accordance with exemplary embodiments.

### DETAILED DESCRIPTION OF THE EMBODIMENTS

According to exemplary embodiments of the present invention, there is provided a flexible window laminate including a window film, a urethane-based elastic film disposed on a bottom surface of the window film, and at least one of a polarizing layer and a touch sensor layer disposed on a bottom surface of the urethane-based elastic film. The flexible window laminate may include the urethane-based elastic film to provide improved anti-shock property while maintaining enhanced folding properties.

According to exemplary embodiments of the present invention, there is also provided an image display device including the flexible window laminate.

Hereinafter, the present invention will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

The term “upper portion”, “low portion”, “top surface”, “bottom surface”, etc., in the present specification are used to indicate a relative positional relation based on the accompanying drawings, and are not intended to indicate an absolute position.

<Flexible Window Laminate>

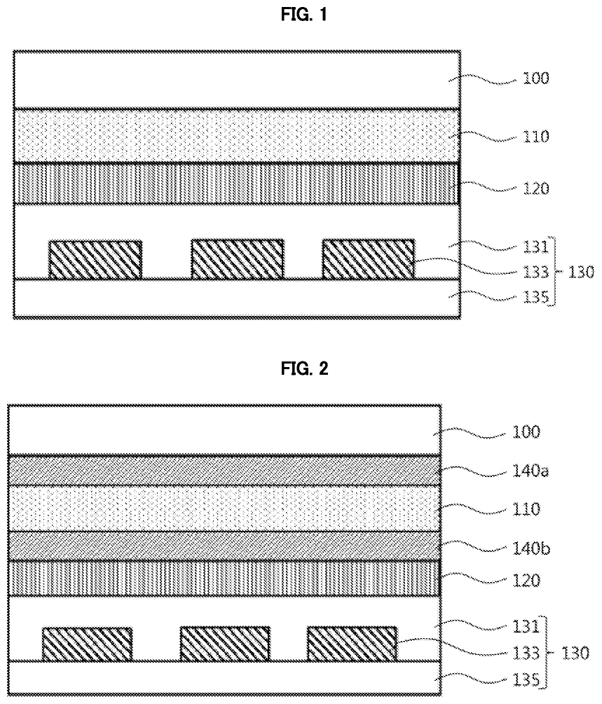

FIGS. 1 and 2 are schematic cross-sectional views illustrating a flexible window laminate in accordance with exemplary embodiments. The flexible window laminate may be employed to an image display device such as a flexible display.

Referring to FIG. 1, the flexible window laminate may include a window film 100, a urethane-based elastic film 110 disposed on the bottom surface of the window film 100, and at least one of a polarizing layer 120 or a touch sensor layer 130 disposed on a bottom surface of the urethane-based elastic film 110.

The window film 100 may serve as an optical substrate of the flexible window laminate. The optical substrate may include, e.g., a material that may be applied to an LCD device, an OLED device, a touch screen panel (TSP), etc., and has a transparency and durability against an external impact. The optical substrate may include a plastic material or a polymer material having a predetermined flexibility. In this case, a display device to which the flexible window laminate is applied may be provided as a flexible display.

For example, the optical substrate may include polyimide (PI), polyethersulphone (PES), polyacrylate (PAR), polyetherimide (PEI), and polyethylene naphthalate (PEN), polyethylene terephthalate (PET), polyphenylene sulfide (PPS), polyallylate, polycarbonate (PC), cellulose triacetate (TAC), cellulose acetate propionate (CAP). These may be used alone or in a combination thereof.

A top surface of the window film 100 may be disposed toward a user's viewing side when the flexible window laminate is applied to an image display device. For example, an image may be implemented to the user toward the top surface of the window film 100, and the user's instruction may be input through the window film 100 (e.g., by the user's touch). For example, the bottom surface of the window film 100 may face a display panel, and additional layers and/or structures of the flexible window laminate may be laminated or disposed on the bottom surface.

In exemplary embodiments, the window film 100 may further include a hard coating layer. For example, the window film 100 may include a stack structure of the above-described optical substrate and the hard coating layer.

For example, the hard coating layer may be disposed on a top surface of the optical substrate. In this case, a surface of the hard coating layer may be exposed to the user's viewing side. The urethane-based elastic film 110, the polarization layer 120, and the touch sensor layer 130 may be laminated on the bottom surface of the optical substrate.

The hard coating layer may be formed using a hard coating composition including a photo-curable compound, a photo-initiator and a solvent, and the widow film 100 may additionally have enhanced flexibility, abrasion resistance, surface hardness, etc.

The photo-curable compound may include, e.g., a siloxane-based compound, an acrylate-based compound, or a compound having a (meth)acryloyl group or a vinyl group. These may be used alone or in combination thereof.

Examples of the siloxane-based compound may include a polydimethylsiloxane (PDMS)-based compound. The siloxane-based compound may contain an epoxy group such as a glycidyl group. Accordingly, a crosslinking or curing reaction through an epoxy ring opening may be promoted by a light irradiation.

Examples of the acrylate-based compound may include dipentaerythritol hexa(meth)acrylate, dipentaerythritol penta(meth)acrylate, pentaerythritol tetra(meth)acrylate, ditrimethylolpropane tetra(meth)acrylate, (meth)acrylate containing an oxyethylene group, ester (meth)acrylate, ether (meth)acrylate, epoxy (meth)acrylate, melamine (meth)acrylate, etc.

Examples of the compound having the (meth)acryloyl group or the vinyl group may include a (meth)acrylic acid ester, an N-vinyl compound, a vinyl-substituted aromatic compound, a vinyl ether, a vinyl ester, etc.

The photo-initiator may not be particularly limited, and may include a compound that initiates a polymerization reaction of the photo-curable compound by generating ions, Lewis acids or radicals by an irradiation of an active energy ray such as visible light, ultraviolet light, X-ray or an electron beam. Examples of the photo-initiator may include an onium salt such as an aromatic diazonium salt, an aromatic iodonium salt and an aromatic sulfonium salt, an acetophenone compound, a benzoin compound, a benzophenone compound, a thioxanthone compound, etc.

The solvent may include a solvent substantially the same or similar to that used in a PSA composition, and is not particularly limited.

In some embodiments, the hard coating composition may further include a UV absorber. The ultraviolet absorber may be used without a particular limitation, and may include a compound capable of absorbing an ultraviolet wavelength of about 380 nm or less. In some embodiments, the ultraviolet absorber may include a benzoxazinone-based compound, a triazine-based compound, a benzotriazole-based compound or a benzophenone-based compound. These may be used alone or in a combination thereof. Accordingly, an ultraviolet transmittance may be reduced by the hard coating layer, so that optical properties and a visible light transmittance of the flexible window laminate may be improved.

For example, the window film 100 may have a single-layered structure of the optical substrate or a multi-layered structure of the hard coating layer and the optical substrate.

In some embodiments, the window film 100 may further include an additional hard coating layer formed on the bottom surface of the optical substrate. In this case, the window film 100 may include a laminated structure of a first hard coating layer—the optical substrate—a second hard coating layer.

For example, the window film 100 may further include at least one functional layer applied to an image display device, such as a UV blocking layer, an anti-scattering layer, an anti-fingerprint layer, etc. For example, a laminate structure including the hard coating layer and the functional layer may be disposed on the top surface of the optical substrate.

As illustrated in FIG. 1, the urethane-based elastic film 110 may be disposed on the bottom surface of the window film 100. The urethane-based elastic film 110 may have a transmittance of 80% or more, preferably 90% or more.

For example, the urethane-based elastic film 110 may be disposed between the window film 100 and the polarizing layer and/or the touch sensor layer. An impact resistance of the flexible window laminate may be improved due to enhanced modulus and hardness of the urethane-based elastic film 110. Further, durability and flexibility of a flexible display including the flexible window laminate may also be improved.

In some embodiments, the urethane-based elastic film may include a transparent polyurethane.

For example, the transparent polyurethane may be polymerized by reacting a polyol in which a diol monomer is polymerized, an isocyanate and a chain extension agent. For example, the polyol, the isocyanate and the chain extension agent may be reacted with a hydroxyl catalyst or under an active condition by an ultraviolet ray.

The transparent polyurethane may include, e.g., a hard block including the isocyanate and the diol monomer and a soft block including the polyol and the isocyanate. In the transparent polyurethane, folding properties may be improved by the soft block, and durability and impact resistance may be improved by the hard block.

For example, the isocyanate may include a C2-C16 alkane diisocyanate such as tetramethylene diisocyanate, hexamethylene diisocyanate, trimethylhexamethylene diisocyanate, etc., 1,4-cyclohexyl diisocyanate, isophorone diisocyanate, 4,4′-methylene bis(cyclohexyl isocyanate), hydrogenated xylene diisocyanate, norbornane diisocyanate, xylene diisocyanate, tetramethyl xylene diisocyanate, phenylene diisocyanate, 1,5-naphthylene diisocyanate, diphenylmethane diisocyanate, tolylene diisocyanate isocyanate, 4,4′-toluidine diisocyanate, 4,4′-diphenyl ether diisocyanate and derivatives thereof. These may be used alone or in a combination thereof.

For example, the polyol may include a polyester polyol, a polyether polyol, a polyether ester polyol, a polycarbonate polyol. These may be used alone or in a combination thereof.

For example, the chain extension agent may include ethylene glycol, propylene glycol, trimethylene glycol, 1,4-butanediol, 1,5-pentanediol, neopentyl glycol, 1,6-hexanediol, 1,4-cyclohexane diol, 1,4-cyclohexanedimethanol, bisphenol A, ethylene oxide, propylene oxide, butylene oxide, diethalolamine, ethylenediamine, propylenediamine, tetramethylenediamine, hexamethylenediamine, 1,4-cyclohexylene diamine, 3-aminomethyl-3,5,5-trimethylcyclohexylamine, isophorone diamine, 4,4′-dicyclohexylmethane diamine, 1,3-bis(aminomethyl) cyclohexane, norbornanediamine, phenylenediamine and m-xylene diamine. These may be used alone or in a combination thereof.

In exemplary embodiments, a thickness of the urethane-based elastic film 110 may be from 20 to 250 μm, preferably from 50 to 200 μm. In the above range, the impact resistance and durability of the urethane-based elastic film 110 may be improved. Further, the durability and flexibility of the flexible window laminate and the flexible display including the same may also be improved.

In exemplary embodiments, the urethane-based elastic film 110 may have an elastic modulus (100% modulus) from 5 to 15 MPa, preferably from 7 to 12 MPa. The elastic modulus is a tensile stress measured at 100% elongation.

In the above range, the urethane-based elastic film 110 may have an excellent restoring force, and thus may have the enhanced impact resistance, durability and bending properties. Accordingly, physical properties of the flexible window laminate and the flexible display including the same may be improved.

In exemplary embodiments, the urethane-based elastic film 110 may have a JIS A hardness from 88 to 98, preferably from 90 to 96. The JIS A hardness is a hardness measured by a spring-type hardness tester according to JIS K 7312.

In the above range, the urethane-based elastic film 110 may have improved bending properties while having the improved impact resistance and durability, and may prevent a film crack due to an external impact. Accordingly, the flexible window laminate and a touch wiring or a display element of the flexible display may be protected from being damaged by the external impact.

In exemplary embodiments, the urethane-based elastic film 110 may have a density from 1 to 1.5, more preferably from 1.1 to 1.25 g/cm³.

In the above range, the urethane-based elastic film 110 may have improved light transmittance and light reflectance while satisfying the above-described physical properties. Accordingly, the physical and optical properties of the flexible window laminate and the flexible display including the urethane-based elastic film 110 may be improved.

The polarizing layer 120 may include a stretched or coated polarizer, preferably may include the coated polarizer. For example, the polarization layer 120 may include a liquid crystal layer.

In some embodiments, the liquid crystal layer may be formed by coating a liquid crystal coating composition on the bottom surface of the urethane-based elastic film 110. In this case, the liquid crystal layer may be in direct contact with the urethane-based elastic film 110. The liquid crystal coating composition may include a reactive liquid crystal compound and a dichroic dye.

The reactive liquid crystal compound may include a reactive mesogen (RM) capable of expressing liquid crystallinity, and a monomer molecule including a polymerizable terminal functional group and having a liquid crystal phase after a crosslinking reaction by heat or light. When the reactive liquid crystal compound is polymerized by light or heat, a polymer network may be formed while maintaining a liquid crystal arrangement. The above-described reactive liquid crystal compound may be utilized so that a thin film-type polarizer having improved mechanical and thermal stability while maintaining optical anisotropy or dielectric property of the liquid crystal may be formed.

The dichroic dye is a component that is included in the liquid crystal coating composition to provide polarization properties, and has different absorbances in a long axis direction and in a short axis direction of the molecule. Non-limiting examples of the dichroic dye may include an acridine dye, an oxazine dye, a cyanine dye, a naphthalene dye, an azo dye, an anthraquinone dye, or the like. These may be used alone or in combination thereof.

The liquid crystal coating composition further includes a solvent capable of dissolving the reactive liquid crystal compound and the dichroic dye, and may include, e.g., propylene glycol monomethyl ether acetate (PGMEA), methyl ethyl ketone (MEK), xylene, chloroform. etc. The liquid crystal coating composition may further include a leveling agent, a polymerization initiator, etc., within a range that does not degrade the polarization properties of the coating film.

The polarization layer 120 may include an alignment layer and the liquid crystal layer. For example, the liquid crystal layer may be formed on the alignment layer.

For example, the alignment layer may be formed by coating and curing an alignment layer coating composition including an alignment polymer, a photo-polymerization initiator and a solvent on the urethane-based elastic film 110, and then the liquid crystal coating composition may be applied and cured on the alignment layer to form the polarization layer 120 including the alignment layer and the liquid crystal layer.

The alignment polymer may include, e.g., a polyacrylate-based resin, a polyamic acid resin, a polyimide-based resin, a polymer including a cinnamate group etc.

The polarizing layer 120 may further include, e.g., an overcoat layer. For example, the overcoat layer may be formed on the liquid crystal layer, and may be disposed on an opposite side of the alignment layer with respect to the liquid crystal layer.

In some embodiments, a protective film may be formed on the overcoat layer. In this case, the polarizing layer 120 may include a laminated structure of the alignment layer, the liquid crystal layer, the overcoat layer and the protective film, and mechanical durability may be further improved while maintaining a transmittance.

The overcoat layer may also substantially serve as an adhesive layer for combining the protective film. In some embodiments, an adhesive layer may be additionally formed between the overcoat layer and the protective film.

The protective film may include, e.g., an optical functional layer. The optical functional layer may include, e.g., a retardation film. The retardation film may be included as a functional layer for a phase retardation of a light penetrating the liquid crystal layer. A material of the retardation film is not particularly limited, and may include a diagonally stretched resin film, a liquid crystal coating layer, or the like.

For example, the retardation film may include a 214 film. The retardation film may have, e.g., a multi-layered structure in which a 214 film and a 212 film are laminated.

In some embodiments, the optical functional layer such as the retardation film may be further laminated on the protective film.

In some embodiments, the polarizing layer 120 may include a stretched polarizer. For example, the polarizing layer 120 may include a first protective film and the stretched polarizer, and the polarizing layer 120 may be substantially provided as a stretched polarizing plate.

The first protective film may include, e.g., a polyester-based resin such as polyethylene terephthalate, polyethylene isophthalate, polyethylene naphthalate, polybutylene terephthalate, etc.; a cellulose resin such as a diacetyl cellulose, a triacetyl cellulose, etc.; a polycarbonate-based resin; an acrylic resin such as polymethyl (meth)acrylate, polyethyl (meth)acrylate; a cyclic olefin-based polymer (COP), or the like.

The stretched polarizer may include, e.g., a stretched polyvinyl alcohol (PVA)-based resin. Preferably, the polyvinyl alcohol-based resin may be a polyvinyl alcohol-based resin obtained by saponifying a polyvinyl acetate-based resin. Examples of the polyvinyl acetate-based resin include polyvinyl acetate which is a homopolymer of vinyl acetate and a copolymer of vinyl acetate and another monomer copolymerizable therewith. Examples of another monomer include an unsaturated carboxylic acid-based monomer, an unsaturated sulfonic acid-based monomer, an olefin-based monomer, a vinyl ether-based monomer, an acrylamide-based monomer having an ammonium group, etc. For example, the polyvinyl alcohol-based resin may also include polyvinyl formal or polyvinyl acetal modified with an aldehyde.

The polarizing layer 120 may further include a second protective film formed on a top surface of the stretched polarizer. Accordingly, the polarizing layer 120 may be provided as a polarizing plate including the first and second protective films and a stretched polarizer sandwiched therebetween.

In an embodiment, the second protective film may include a material substantially the same as or similar to that of the first protective film.

In an embodiment, the second protective film may include an optical functional layer. The optical functional layer may include the retardation film as mentioned above.

In some embodiments, the second protective film may include a material substantially the same as or similar to that of the first protective film, and the optical functional layer such as the retardation film may be further formed on the second protective film.

The touch sensor layer 130 may include a substrate 135, an electrode 133 disposed on the substrate 135 and an insulating layer 131 covering the electrode 133.

The substrate 135 may include a flexible resin film such as polyimide. The electrode 133 may include a sensing electrode configured to sense a touch through a change in capacitance, and a pad electrode for a signal transmission.

For example, the electrode 133 may include a metal, a metal wire (e.g., a metal nanowire) or a transparent conductive oxide.

The metal may include silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), calcium (Ca) or an alloy containing at least one of the metals. These may be used alone or in a combination of two or more therefrom.

Examples of the transparent conductive oxide may include indium tin oxide (ITO), indium zinc oxide (IZO), zinc oxide (ZnO), indium zinc tin oxide (IZTO), cadmium tin oxide (CTO), etc.

In an embodiment, the electrode 133 may include a multi-layered structure such as the transparent metal oxide—the metal wire, or the transparent metal oxide—the metal (or the metal wire)—the transparent metal oxide.

In some embodiments, the touch sensor layer 130 may include a touch sensor operated in a mutual-capacitance method. In this case, the sensing electrode may include first sensing electrodes and second sensing electrodes that may be arranged to cross each other in different directions (e.g., X and Y directions) to sense the user's touch position.

For example, unit patterns of the first sensing electrodes may be connected to each other to define a sensing line, and a plurality of the sensing lines may be arranged. Each of the second sensing electrodes may include unit patterns that are physically spaced apart from each other. For example, a bridge electrode for electrically connecting the second sensing electrodes adjacent to each other with the first sensing electrode interposed therebetween may be further included. In this case, the insulating layer 131 may serve as a support pattern of the bridge electrode, and may include an insulating pattern for insulating the first and second sensing electrodes from each other.

In some embodiments, the touch sensor layer 130 may include a touch sensor operated in a self-capacitance method. In this case, the electrodes 133 may include unit patterns that are physically spaced apart from each other. Each of the unit patterns may be electrically connected to a driving circuit via a trace or a wiring line.

The unit patterns may be formed by, e.g., patterning a mesh metal electrode into a polygonal shape.

The insulating layer 131 may cover the electrodes 133 on the substrate 135. The insulating layer 131 may include, e.g., an inorganic insulating material such as silicon oxide or a transparent organic material such as an acrylic resin.

In some embodiments, the substrate 135 of the touch sensor layer 130 may include a separation layer and/or an intermediate layer.

In some embodiments, the separation layer and/or the intermediate layer may substantially serve as the substrate 135.

The separation layer may include a polymer organic layer. Non-limiting examples of a polymer material included in the polymer organic layer may include a polyimide-based polymer, a polyvinyl alcohol-based polymer, a polyamic acid-based polymer, a polyamide-based polymer, a polyethylene-based polymer, a polystyrene-based polymer, and a polynorbornene-based polymer, a phenylmaleimide copolymer, a polyazobenzene-based polymer, a polyphenylene phthalimide-based polymer, a polyester-based polymer, a polymethyl methacrylate-based polymer, a polyarylate-based polymer, a cinnamate-based polymer, a coumarin-based polymer, a phthalimidine-based polymer, a chalcone-based polymer, an aromatic acetylene-based polymer, etc. These may be used alone or in a combination of two or more therefrom.

In some embodiments, the separation layer may be formed on a carrier substrate such as a glass substrate, and may be formed to promote a peeling process from the carrier substrate after forming the electrode and the insulating layer.

The intermediate layer may be formed to protect the electrodes of the touch sensor layer 130 and to provide a refractive index matching with the electrodes. For example, the intermediate layer may be formed to include an inorganic insulating material such as silicon oxide, silicon nitride, silicon oxynitride, etc., or a polymer-based organic insulating material.

An adhesive layer may be formed on the touch sensor layer 130, and a protective film may be attached on the adhesive layer. For example, after attaching the protective film, the carrier substrate may be removed. After removing the protective film, the touch sensor layer 130 may be laminated on the polarizing layer 120 using the adhesive layer.

In some embodiments, after peeling off the carrier substrate, a substrate may be additionally adhered to the separation layer.

In some embodiments, any one of the separation layer and the intermediate layer may be omitted.

Referring to FIG. 1, the polarization layer 120 and the touch sensor layer 130 may be sequentially disposed from the bottom surface of the urethane-based elastic film 110. Accordingly, a double-layered protective structure of the urethane-based elastic film 110 and the polarizing layer 120 may be formed, thereby more effectively preventing damage to the electrodes 133 of the touch sensor layer from the external impact.

Referring to FIG. 2, a first adhesive layer 140a may be disposed between the window film 100 and the urethane-based elastic film 110 to combine the urethane-based elastic film 110 and the window film 100 with each other. A second adhesive layer 140b may be disposed between the urethane-based elastic film 110 and the polarizing layer 120 to combine the urethane-based elastic film 110 and the polarizing layer 120.

The term “adhesive layer” used herein encompasses a pressure sensitive adhesive layer and a bonding layer. The adhesive layer may be formed using a pressure sensitive adhesive (PSA) composition or an optically clear adhesive (OCA) composition.

The adhesive layer may have an appropriate adhesive strength so that peeling, bubbles, etc., may not occur while the flexible window laminate is bent, and may also have a viscoelastic property to be applied to the flexible display. In some embodiments, in consideration of the above-described aspect, the adhesive layer may be formed using an acrylate-based PSA composition. For example, the PSA composition may include a (meth)acrylic acid ester copolymer, a crosslinking agent, and a solvent.

The type of the crosslinking agent is not particularly limited, and may be appropriately selected from those commonly used in the art. For example, the crosslinking agent may include a polyisocyanate compound, an epoxy resin, a melamine resin, a urea resin, a dialdehyde, a methylol polymer, or. Preferably, the polyisocyanate compound may be used.

The solvent may include a conventional solvent used in the field of a resin composition. For example, an alcohol-based solvent (methanol, ethanol, isopropanol, butanol, propylene glycol methoxy alcohol, etc.), a ketone-based solvent (methyl ethyl ketone, methyl butyl ketone, methyl isobutyl ketone, diethyl ketone, dipropyl ketone, etc.), an acetate-based solvent (methyl acetate, ethyl acetate, butyl acetate, propylene glycol methoxy acetate, etc.), a cellosolve-based solvent (methyl cellosolve, ethyl cellosolve, propyl cellosolve, etc.), a hydrocarbon-based solvent (normal hexane, normal heptane, benzene, toluene, xylene, etc.) may be used. These may be used alone or in combination of two or more therefrom.

In some embodiments, the adhesive layer may be disposed between the layers and/or films adjacent to each other as described above to adhere the layers and/or films to each other.

The flexible window laminate according to the above-described embodiments of the present invention may have the urethane-based elastic film. Accordingly, when the flexible window laminate is applied to the flexible display such as a flexible OLED device, mechanical properties such as flexibility, reliability, durability and impact resistance may be improved.

Therefore, touch wirings or the display elements included in the flexible display may be prevented from being damaged by the external impact.

<Image Display Device>

According to embodiments of the present invention, an image display device including the above-described flexible window laminate is provided. The flexible window laminate may be combined with a display panel included in an OLED device, an LCD device, or the like. The display panel may include a pixel circuit including a thin film transistor (TFT) arranged on a substrate, and a pixel unit or a light emitting unit electrically connected to the pixel circuit.

For example, the flexible window laminate as described with reference to FIGS. 1 and 2 may be disposed on the display panel.

The image display device may be a flexible display, and mechanical defects or damages such as cracks, peelings and fractures may be suppressed by the improved flexibility and durability of the flexible window laminate even during an operation such as folding and bending.

Hereinafter, preferred embodiments are proposed to more concretely describe the present invention. However, the following examples and comparative examples are only given for illustrating the present invention, and are not to restrict the scope of the invention. Those skilled in the related art will obviously understand that various alterations and modifications are possible within the scope and spirit of the present invention, and such alterations and modifications are duly included in the appended claims.

### EXAMPLES AND COMPARATIVE EXAMPLES

### Example 1

(1) Fabrication of Laminate of Window Film-Urethane-Based Elastic Film Laminate

Commercially available transparent polyurethane film having properties as shown in Table 1 below were prepared. A first adhesive layer was formed on an optical polyimide film (a window film) having a thickness of 80 μm, and the urethane-based elastic film was attached to the first adhesive layer to prepare a window film-urethane-based elastic film laminate.

(2) Fabrication of Flexible Window Laminate

A second adhesive layer was formed on an opposite surface of the urethane-based elastic film with respect to the surface to which the window film was attached, and a polyvinyl alcohol (PVA) polarizer having a thickness of 20 μm was attached to the second adhesive layer.

A touch sensor layer including an ITO pattern of 45 nm as an electrode and a silicon oxide insulating layer covering the electrode was transferred on the polarizer to prepare a flexible window laminate.

TABLE 1

| | Example | Example | Example | Example | Example | Example | Example |
|---|---|---|---|---|---|---|---|
| | 1 | 2 | 3 | 4 | 5 | 6 | 7 |
| Thickness (μm) | 100 | 200 | 200 | 200 | 200 | 200 | 200 |
| Hardness | 90 ± 2 | 90 ± 2 | 90 ± 2 | 90 ± 2 | 90 ± 2 | 90 ± 2 | 90 ± 2 |
| (JIS A) | | | | | | | |
| Tensile | 45 | 45 | 50 | 45 | 45 | 45 | 45 |
| Strength | | | | | | | |
| (MPa) | | | | | | | |
| Elongation | 550 | 550 | 450 | 550 | 550 | 550 | 550 |
| (%) | | | | | | | |
| Elastic | 7.4 | 7.4 | 11.5 | 7.4 | 7.4 | 4 | 16 |
| Modulus | | | | | | | |
| (MPa) | | | | | | | |
| 300% Modulus | 15.4 | 15.4 | 24 | 15.4 | 15.4 | 15.4 | 15.4 |
| (MPa) | | | | | | | |
| Tear Resistance | 120 | 120 | 140 | 120 | 120 | 120 | 120 |
| (KN/m) | | | | | | | |
| Abrasion loss | 70 | 70 | 25 | 70 | 70 | 70 | 70 |
| (mg) | | | | | | | |
| Compressive | 25 | 25 | −21 | 25 | 25 | 25 | 25 |
| Strain (%) | | | | | | | |
| Density (g/cm³) | 1.23 | 1.23 | 1.13 | 0.7 | 20 | 1.23 | 1.23 |
| Elastic | 42 | 42 | 30 | 42 | 42 | 42 | 42 |
| section (%) | | | | | | | |
| Reflectance | 8.88 | 8.8820 | 9.12 | 8.8820 | 8.8820 | 8.8820 | 8.8820 |
| (%) | | | | | | | |
| Transmittance | 83.9 | 83.9 | 90.4 | 83.9 | 83.9 | 83.9 | 83.9 |
| (%) | | | | | | | |
| CIELab (a*) | 0.185 | 0.185 | 0.045 | 0.185 | 0.185 | 0.185 | 0.185 |
| CIELab (b*) | 0.165 | 0.165 | 0.27 | 0.165 | 0.165 | 0.165 | 0.165 |

### Examples 2 to 7

Flexible window laminates were manufactured by the same processes as that in Example 1, except that the urethane-based elastic film having the properties as shown in Table 1 were used.

### Comparative Example 1

A flexible window laminate was manufactured by the same process as that in Example 1, except that a polyvinyl alcohol (PVA) polarizer was directly attached to the window film without attaching the transparent polyurethane film.

### Comparative Example 2

A flexible window laminate was manufactured by the same process as that in Example 1, except that polyethylene terephthalate (PET) was attached to the window film instead of the transparent polyurethane film.

### Comparative Example 3

A flexible window laminate was manufactured by the same process as that in Example 1, except that a pressure sensitive adhesive (PSA) was attached to the window film instead of the urethane-based elastic film.

### Experimental Example

Samples each having a length of 50 mm×a width of 50 mm were prepared using the flexible window laminates of Examples 1 to 7 and Comparative Examples 1 to 3 above. An impact evaluation was performed by dropping an object in which a pen (BIC ball-point-pen) and an iron bead (2.72 g) were combined from a distance of 10 cm in a vertical upward direction from the sample. Appearance evaluation, functional evaluation of the touch sensor and damage evaluation using a microscope were performed on the sample after the impact evaluation was completed. The above experiment was repeated 7 times.

A weight of the iron beads was changed to 6.9 g, 10.2 g, 14 g, 18.9 g, 21.7 g, 24.8 g, 31.9 g and 35.85 g, and the same impact evaluation, appearance evaluation, functional evaluation of touch sensor and damage evaluation through the microscope were repeatedly performed.

Table 2 shows the evaluation results of the touch sensor function of the flexible window laminate after the impact evaluation according to the change of the weight of the iron beads.

O: normal

X: bad

TABLE 2

| Weight of | | | | | | | | | Comparative | Comparative | Comparative |
|---|---|---|---|---|---|---|---|---|---|---|---|
| the bead | | Example | Example | Example | Example | Example | Example | Example | Example | Example | Example |
| (g) | | 1 | 2 | 3 | 4 | 5 | 6 | 7 | 1 | 2 | 3 |
| 2.72 | g | ◯ | ◯ | ◯ | ◯ | ◯ | ◯ | ◯ | ◯ | ◯ | ◯ |
| 6.9 | g | ◯ | ◯ | ◯ | ◯ | ◯ | ◯ | ◯ | ◯ | ◯ | ◯ |
| 10.2 | g | ◯ | ◯ | ◯ | ◯ | ◯ | ◯ | ◯ | ◯ | ◯ | ◯ |
| 14 | g | ◯ | ◯ | ◯ | ◯ | ◯ | ◯ | ◯ | ◯ | ◯ | ◯ |
| 18.9 | g | ◯ | ◯ | ◯ | ◯ | ◯ | ◯ | ◯ | ◯ | ◯ | ◯ |
| 21.7 | g | ◯ | ◯ | ◯ | ◯ | ◯ | ◯ | ◯ | X | ◯ | ◯ |
| 24.8 | g | ◯ | ◯ | ◯ | ◯ | ◯ | ◯ | ◯ | X | ◯ | ◯ |
| 31.9 | g | ◯ | ◯ | ◯ | ◯ | ◯ | ◯ | ◯ | X | X | X |
| 35.85 | g | X | ◯ | ◯ | X | X | X | X | X | X | X |

Table 3 shows the results of microscopic observation on whether the flexible window laminate was damaged after the impact evaluation according to the change of the weight of the iron beads. Additionally, n/7 (e.g., 3/7) in Table 3 means that breakage occurred in n (e.g., 3) samples among 7 samples.

O: No breakage

X: breakage occurred

TABLE 3

| Weight of | | | | | | | | | Comparative | Comparative | Comparative |
|---|---|---|---|---|---|---|---|---|---|---|---|
| the bead | | Example | Example | Example | Example | Example | Example | Example | Example | Example | Example |
| (g) | | 1 | 2 | 3 | 4 | 5 | 6 | 7 | 1 | 2 | 3 |
| 2.72 | g | ◯ | ◯ | ◯ | ◯ | ◯ | ◯ | ◯ | ◯ | ◯ | ◯ |
| 6.9 | g | ◯ | ◯ | ◯ | ◯ | ◯ | ◯ | ◯ | ◯ | ◯ | ◯ |
| 10.2 | g | ◯ | ◯ | ◯ | ◯ | ◯ | ◯ | ◯ | ◯ | ◯ | ◯ |
| 14 | g | ◯ | ◯ | ◯ | ◯ | ◯ | ◯ | ◯ | ◯ | ◯ | ◯ |
| 18.9 | g | ◯ | ◯ | ◯ | ◯ | ◯ | ◯ | ◯ | X(7/7) | X(3/7) | X(4/7) |
| 21.7 | g | ◯ | ◯ | ◯ | X(3/7) | X(4/7) | X(3/7) | X(3/7) | X(7/7) | X(7/7) | X(3/7) |
| 24.8 | g | X(1/7) | ◯ | ◯ | X(5/7) | X(6/7) | X(5/7) | X(5/7) | X(7/7) | X(7/7) | X(7/7) |
| 31.9 | g | X(4/7) | ◯ | ◯ | X(7/7) | X(7/7) | X(7/7) | X(7/7) | X(7/7) | X(7/7) | X(7/7) |
| 35.85 | g | X(7/7) | X(2/7) | X(5/7) | X(7/7) | X(7/7) | X(7/7) | X(7/7) | X(7/7) | X(7/7) | X(7/7) |

Table 4 shows the results of comprehensive evaluation. Each weight listed in Table 4 represents a maximum weight of the iron bead that did not cause defects or breakage in the flexible window laminate. Additionally, X means that defects occurred in all cases after the impact evaluation.

TABLE 4

| | | | | | | | | | | | | | | | Comparative | | Comparative | | Comparative | |
|---|---|---|---|---|---|---|---|---|---|---|---|---|---|---|---|---|---|---|---|---|
| | Example | | Example | | Example | | Example | | Example | | Example | | Example | | Example | | Example | | Example | |
| | 1 | | 2 | | 3 | | 4 | | 5 | | 6 | | 7 | | 1 | | 2 | | 3 | |
| Appearance | 18.9 | g | 24.8 | g | 24.8 | g | 14 | g | 14 | g | 14 | g | 14 | g | X | | 2.72 | g | 6.9 | g |
| Evaluation | | | | | | | | | | | | | | | | | | | | |
| Functional | 31.9 | g | 35.85 | g | 35.85 | g | 31.9 | g | 31.9 | g | 31.9 | g | 31.9 | g | 18.9 | g | 24.8 | g | 24.8 | g |
| Evaluation | | | | | | | | | | | | | | | | | | | | |
| Damage | 21.7 | g | 31.9 | g | 31.9 | g | 18.9 | g | 18.9 | g | 18.9 | g | 18.9 | g | 14 | g | 14 | g | 14 | g |
| Evaluation | | | | | | | | | | | | | | | | | | | | |

Referring to Tables 2 to 4, in Examples including the transparent polyurethane film, excellent impact resistances to the external impact were provided. In Comparative Examples in which the transparent polyurethane film was not included, or the PET or PSA film was included, the impact resistances of the flexible window laminates were deteriorated.

In Examples 4 and 5 where the density of the transparent polyurethane film was not within a range from 1 to 1.5 g/cm³, and in Examples 6 and 7 where the elastic modulus was not within a range from 5 to 15 MPa, the impact resistance and durability were degraded relatively to those from Examples 1 to 3 satisfying the above ranges.

What is claimed is:

1. A flexible window laminate, comprising:
a window film;
a urethane-based elastic film disposed on a bottom surface of the window film; and
at least one of a polarizing layer and a touch sensor layer disposed on a bottom surface of the urethane-based elastic film.

2. The flexible window laminate according to claim 1, wherein the urethane-based elastic film includes transparent polyurethane.

3. The flexible window laminate according to claim 1, wherein a thickness of the urethane-based elastic film is from 20 to 250 μm.

4. The flexible window laminate according to claim 1, wherein an elastic modulus of the urethane-based elastic film is from 5 to 15 MPa.

5. The flexible window laminate according to claim 1, wherein the urethane-based elastic film has a JIS A hardness of 88 to 98.

6. The flexible window laminate according to claim 1, wherein the urethane-based elastic film has a density of 1 to 1.5 g/cm³.

7. The flexible window laminate according to claim 1, wherein the polarizing layer and the touch sensor layer are sequentially stacked from the bottom surface of the urethane-based elastic film.

8. The flexible window laminate according to claim 7, further comprising a first adhesive layer disposed between the window film and the urethane-based elastic film layer, and a second adhesive layer disposed between the urethane-based elastic film and the polarizing layer.

9. An image display device comprising the flexible window laminate according to claim 1.

10. The image display device according to claim 9, wherein the image display device is a flexible display device.
